(19) United States
(12) Patent Application Publication
(10) Pub. No.: US 2017/0034989 A1
(43) Pub. Date: Feb. 9, 2017

(54) Implement Leveling System

(71) Applicant: Summers Manufacturing Company, Inc., Devils Lake, ND (US)

(72) Inventors: Travis E. Westlind, Devils Lake, ND (US); Paul J. Wilhelmi, Devils Lake, ND (US)

(21) Appl. No.: 15/230,923

(22) Filed: Aug. 8, 2016

Related U.S. Application Data
(60) Provisional application No. 62/282,626, filed on Aug. 7, 2015.

(51) Int. Cl. A01B 63/22; A01B 63/00

(52) U.S. Cl. CPC A01B 63/22; A01B 63/008; A01C 21/002

(57) ABSTRACT

An implement leveling system for efficiently leveling an implement or other device. The implement leveling system generally includes an implement having a frame, a plurality of wheels connected to the implement by corresponding wheel support structures and an adjustable actuator connected to each of the wheel support structures. The adjustable actuator includes a first actuator extending in a first direction and a second actuator extending in a second direction. A plurality of shims are connected to the first actuator, wherein the shims each have a storage position and an engaged position. When a shim is in the engaged position, the shim is positioned between a first end mount and a first head of the first actuator to adjust the minimum length of the adjustable actuator. The minimum length for each of the adjustable actuators may be adjusted by selecting the desired number of shims to be in the engaged position.

### CROSS REFERENCE TO RELATED APPLICATIONS

I hereby claim benefit under Title 35, United States Code, Section 119(e) of U.S. provisional patent application Ser. No. 62/282,626 filed Aug. 7, 2015 (Attorney Docket No. SUMM-004). The 62/282,626 application is currently pending. The 62/282,626 application is hereby incorporated by reference into this application.

### STATEMENT REGARDING FEDERALLY SPONSORED RESEARCH OR DEVELOPMENT

Not applicable to this application.

### BACKGROUND

Field

Example embodiments in general relate to an implement leveling system for efficiently leveling an implement or other device.

Related Art

Any discussion of the related art throughout the specification should in no way be considered as an admission that such related art is widely known or forms part of common general knowledge in the field.

Linear actuators (e.g. hydraulic cylinders) are utilized to extend and retract various components within an implement (e.g. agricultural implement). A linear actuator has a maximum length when fully extended and a minimum length when fully retracted.

For example, hydraulic cylinders are utilized on various types of agricultural implements (e.g. fertilizer applicator implement) to lift and lower the central frame and wings of the agricultural implement supported above the ground surface by a plurality of wheels. A tractor pulling the agricultural implement will use the hydraulic system of the tractor to provide pressurized hydraulic fluid to the hydraulic cylinders on the agricultural implement to lift and lower agricultural implement with respect to the ground surface. When the agricultural implement is a fertilizer applicator implement, the operator will lower the central frame and wings of the fertilizer applicator implement by fully retracting the hydraulic cylinders connected to the wheels. The minimum length of each of the hydraulic cylinders controls the depth of fertilizer application into the soil in the general area of the fertilizer applicator implement surrounding each hydraulic cylinder.

As agricultural implements such as fertilizer applicator implements have grown in size, it is become increasingly important to level the agricultural implement so that the depth of penetration into the soil is consistent throughout the entire agricultural implement. The most common method used today for leveling an agricultural implement is the usage of threaded rod (e.g. I-bolt) extending from the base end of the hydraulic cylinder that has a plurality of threaded nuts used to adjust the static position of the hydraulic cylinder with respect to the frame of the agricultural implement.

Unfortunately, utilizing threaded rods to adjust the minimum length of each hydraulic cylinder on a large implement can be time consuming and difficult for a user. In addition, manually adjusting the minimum length of the hydraulic cylinders requires tools which the operator may or may not have while in the field. Furthermore, because of the inconvenience of leveling the agricultural implement, operators will sometimes either ineffectively level or not level the agricultural implement at all resulting in inconsistent penetration of the soil by the agricultural implement.

### SUMMARY

An example embodiment of the present invention is directed to an implement leveling system. The implement leveling system includes an implement having a frame, a plurality of wheels connected to the implement by corresponding wheel support structures and an adjustable actuator connected to each of the wheel support structures. The adjustable actuator includes a first actuator extending in a first direction and a second actuator extending in a second direction. A plurality of shims are connected to the first actuator, wherein the shims each have a storage position and an engaged position. When a shim is in the engaged position, the shim is positioned between a first end mount and a first head of the first actuator to adjust the minimum length of the adjustable actuator. The minimum length for each of the adjustable actuators may be adjusted by selecting the desired number of shims to be in the engaged position. It can be appreciated other embodiments of the present invention may be used on various other devices that are not implements and furthermore only a single adjustable actuator may be used on a device. Furthermore, the various embodiments of the present invention are not limited to only leveling applications and may be used for various other purposes other than leveling.

There has thus been outlined, rather broadly, some of the features of the implement leveling system in order that the detailed description thereof may be better understood, and in order that the present contribution to the art may be better appreciated. There are additional features of the implement leveling system that will be described hereinafter and that will form the subject matter of the claims appended hereto. In this respect, before explaining at least one embodiment of the implement leveling system in detail, it is to be understood that the implement leveling system is not limited in its application to the details of construction or to the arrangements of the components set forth in the following description or illustrated in the drawings. The implement leveling system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1a is a perspective view of an implement leveling system in accordance with an example embodiment for an agricultural implement comprised of a fertilizer applicator implement.

FIG. 1b is a perspective view of an embodiment of the present invention utilized on a support structure for a wheel of an agricultural implement to raise and lower the wheel with respect to the frame of the implement.

FIG. 1c is a side view of an embodiment of the present invention utilized on a support structure for a wheel of an agricultural implement to raise and lower the wheel with respect to the frame of the implement.

FIGS. 2a through 2d are perspective views of an embodiment of the present invention illustrating the process of positioning all of the shims from the storage position to the engaged position.

FIGS. 3a through 3d are perspective views of an embodiment of the present invention illustrating the process of positioning a selected number of the shims from the storage position to the engaged position.

FIGS. 4a and 4b are perspective views of an embodiment of the present invention illustrating the process of positioning two shims from the storage position to the engaged position.

FIGS. 4c and 4d are top views of an embodiment of the present invention illustrating the process of positioning two shims from the storage position to the engaged position.

FIGS. 5a and 5b are top views of an embodiment of the present invention illustrating the process of positioning four shims from the storage position to the engaged position.

FIGS. 6a and 6b are top views of an embodiment of the present invention illustrating the process of positioning six shims from the storage position to the engaged position.

FIGS. 7a through 7c are top views of an embodiment of the present invention illustrating the process of positioning all of the shims from the storage position to the engaged position.

FIGS. 8a through 8b are first side views of an embodiment of the present invention illustrating the process of positioning eight of the shims from the storage position to the engaged position.

FIG. 9 is a second side view opposite of the side shown in FIGS. 8a and 8b with all of the shims in the storage position.

FIG. 10 is an end view of the second actuator in an embodiment of the present invention.

FIGS. 11a through 11c are end views of the first actuator in an embodiment of the present invention illustrating the process of positioning all of the shims from the storage position to the engaged position.

FIG. 12 is a cross sectional view taken along line 12-12 of FIG. 2a.

FIG. 13 is a cross sectional view taken along line 13-13 of FIG. 4d.

FIG. 14 is a cross sectional view taken along line 14-14 of FIG. 4c.

FIG. 15 is a block diagram of an embodiment of the present invention illustrating the control of pressurized hydraulic fluid to the first actuators and the second actuators.

FIG. 16 is a perspective view of an embodiment of the present invention illustrating the flow control valve and the secondary control valve attached to the implement.

FIG. 17 is a flowchart of an embodiment of the present invention illustrating the process of leveling an implement.

### DETAILED DESCRIPTION

### A. Overview

An example implement leveling system generally comprises an implement 10 having a frame, a plurality of wheels connected to the implement 10 by corresponding support structures and an adjustable actuator 20 connected to each of the support structures. The adjustable actuator 20 includes a first actuator 30 extending in a first direction and a second actuator 40 extending in a second direction. A plurality of shims 70 are connected to the first actuator 30, wherein the shims 70 each have a storage position and an engaged position. When a shim 70 is in the engaged position, the shim 70 is positioned between a first end mount 36 and a first head 32 of the first actuator 30 to adjust the minimum length of the adjustable actuator 20. The minimum length for each of the adjustable actuators 20 may be adjusted by selecting the desired number of shims 70 to be in the engaged position.

While it is preferable that the various embodiments of the present invention are utilized upon a group of linear actuators for the purposes of leveling a structure manipulated by the linear actuators (e.g. agricultural implement 10), the various embodiments of the present invention may be utilized upon a single linear actuator for various types of applications whether or not agricultural related to provide for efficient adjustment of the minimum length of the linear actuator. Hence, the various embodiments of the present invention include a single adjustable actuator 20 that may be utilized in any manner on any type of device.

### B. Exemplary Implement

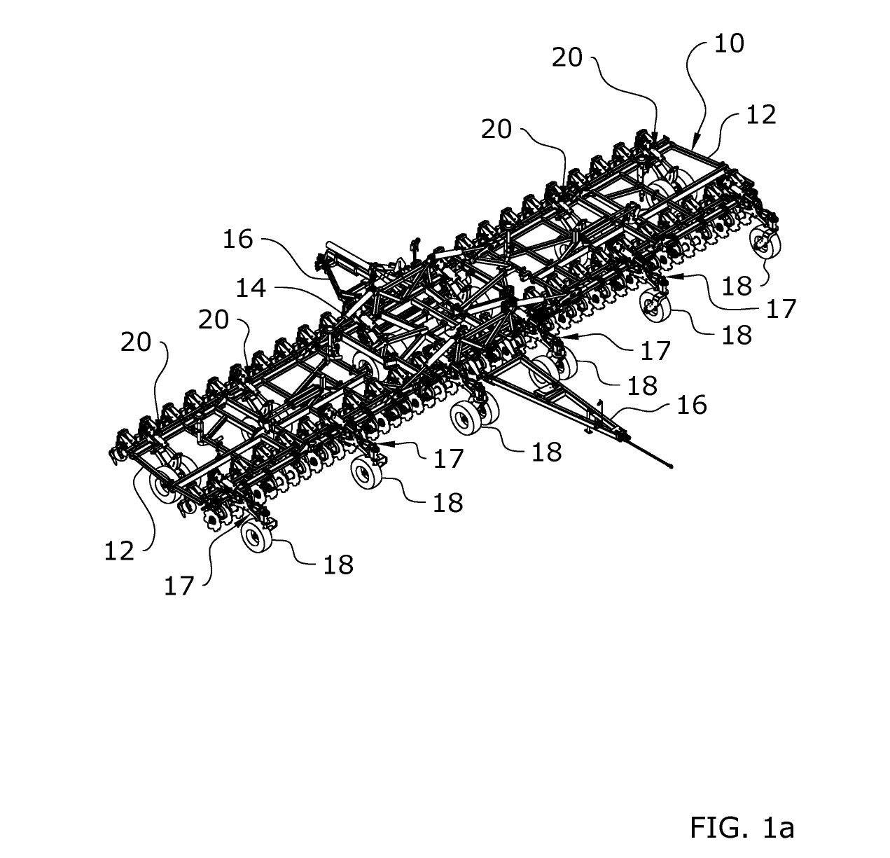

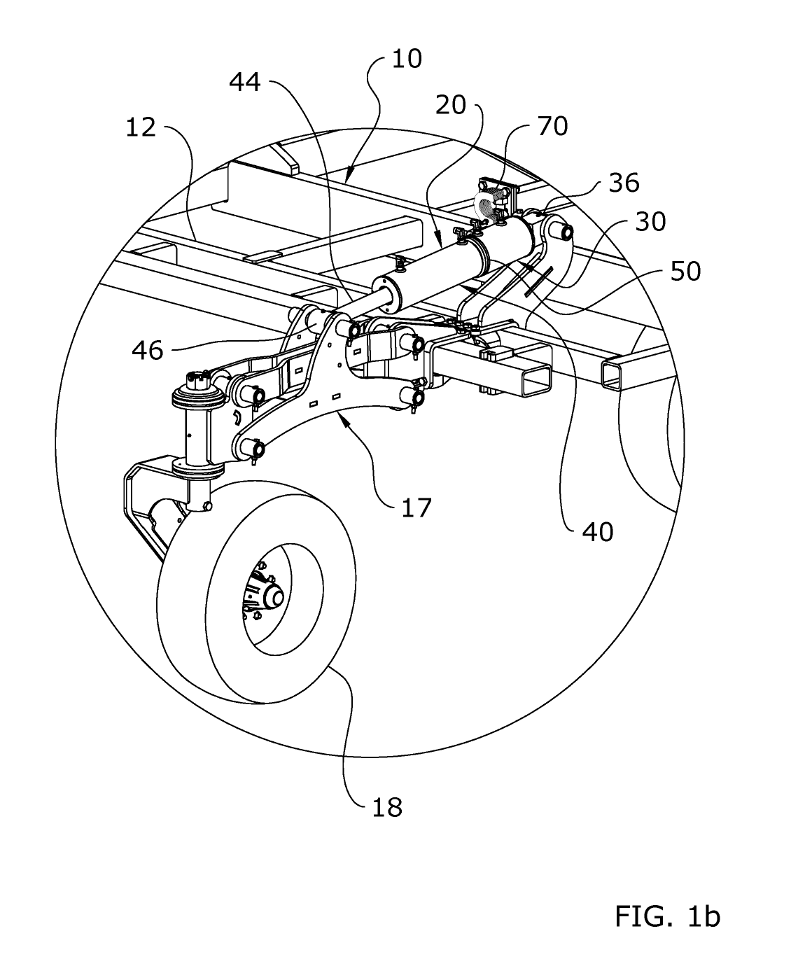

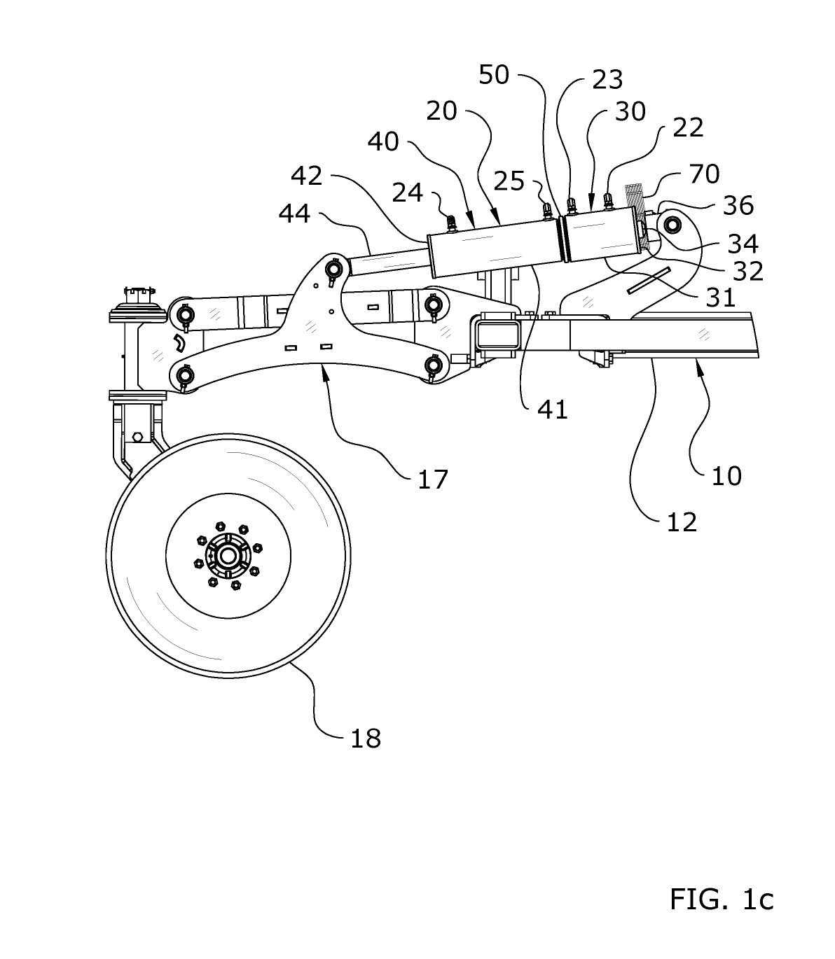

The various embodiments of the present invention are preferably utilized upon an implement 10. It is further preferable that the present invention is utilized upon an agricultural implement 10 such as fertilizer applicators, disk harrows, chisel plows, harrows, plows, field cultivators, planters, rakes, harvesters, swathers and the like. While the various preferred embodiments of the present invention are used with respect to agricultural implements 10, the present invention may be utilized to adjust the minimum length of a linear actuator on various other types of implements, machines, equipment, tools and industrial machinery. While FIG. 1a illustrates one embodiment of the present invention utilized upon a fertilizer applicator implement 10, the present invention is not limited to fertilizer applicator implements or agricultural implements.

FIG. 1a illustrates an exemplary implement 10 comprised of a fertilizer applicator (e.g. liquid fertilizer applicator). The exemplary implement 10 illustrated in FIG. 1a includes a frame, a hitch 16 extending from the frame for attaching to a tractor, a plurality of wheel assemblies 17 connected to the frame, and a plurality of fertilizer application units extending downwardly from the frame adapted to apply fertilizer into the ground at a desired depth. The fertilizer application units may be comprised of any well-known fertilizer applicator devices such as liquid fertilizer injection knives. The knives of the fertilizer applicator penetrate the ground surface to inject the fertilizer at a desired depth in the ground. It is important that the fertilizer be applied at a precise and consistent depth by the fertilizer applicator to ensure effective usage of the fertilizer and to prevent damage to crops. U.S. Pat. No. 8,667,915 illustrates an exemplary fertilizer applicator suitable for usage with the present invention and is incorporated by reference herein. U.S. Pat. No. 6,397,767 illustrates an exemplary liquid knife applicator suitable for usage with the present invention and is hereby incorporated by reference herein.

The exemplary implement 10 in FIG. 1a illustrates a frame having a central frame 14, a first wing frame 12 movably connected to the central frame 14 and a second wing frame 12 movably connected to the central frame 14 opposite of the first wing frame 12. The wing frames 12 are typically pivotally connected to the central frame 14 to allow for moving the wing frames 12 into a storage position for travel on a road. Furthermore, more than one wing frame 12 may extend from each side of the central frame 14. In addition, the frame may not include wing frames 12 and instead may be comprised of a single frame structure.

FIGS. 1a through 1c illustrate the wheel assemblies 17 that support the frame including the central frame 14 and the wing frames 12 above a ground surface. The wheel assemblies 17 determine the depth that each of fertilizer applicator units (e.g. knife applicator) applies the fertilizer into the ground surface below the corresponding portion of the frame. Each of the wheel assemblies 17 include at least one wheel 18, at least one arm connected to the frame and at least one adjustable actuator 20. The adjustable actuator 20 is preferably connected between the frame and the wheel assembly 17, however, the adjustable actuator 20 may only be connected to the wheel assembly 17 in a direct manner without a direct connection to the frame of the implement 10. There can be any number of arms for each wheel assembly 17 and FIGS. 1b and 1c illustrate the usage of a pair of arms to support the wheel 18.

The adjustable actuator 20 is adapted for lifting and lowering a corresponding wheel assembly 17. The adjustable actuator 20 has a minimum length that is adjustable and a maximum length that is also adjustable as discussed further herein. The minimum length of the adjustable actuator 20 determines the maximum depth into the ground surface that a fertilizer applicator unit near the corresponding wheel assembly 17 applies the fertilizer when the fertilizer applicator is in fertilizer application mode. The maximum length of the adjustable actuator 20 determines the maximum height above the ground surface that a fertilizer applicator unit near the corresponding wheel assembly 17 is when the implement 10 is in transport mode.

### C. Adjustable Actuator

The adjustable actuator 20 is comprised of a double ended linear actuator structure. The adjustable actuator 20 includes a first actuator 30 that extends in a first direction and a second actuator 40 that extends in a second direction. The first actuator 30 and the second actuator 40 extend and retract respectively and preferably independent of one another. The first actuator 30 is connected to the second actuator 40 as further discussed herein. The first actuator 30 is temporarily utilized to adjust the minimum length and the maximum length of the adjustable actuator 20 thereby determining the minimum height and maximum height of the implement 10 respectively. The second actuator 40 is utilized to control the current length of the adjustable actuator 20 during normal operation of the implement 10 thereby controlling the height of the implement 10 above the ground surface during normal operation (e.g. during the application of fertilizer to the ground). The adjustable actuator 20 may be utilized for other applications other than raising and lowering the implement 10 with respect to a ground surface (e.g. folding a wing frame 12 on the implement 10).

The terms actuator, adjustable actuators 20, first actuators 30 and second actuators 40, shall include any type of linear actuator such as, but not limited to, hydraulic cylinders, pneumatic actuators, electro-mechanical actuators and the like. Furthermore, the first actuators 30 and second actuators 40 described in the various embodiments of the present invention may be comprised of the same type of linear actuator or different types of linear actuators. For example, the first actuator 30 may be comprised of an electro-mechanical actuator and the second actuator 40 may be comprised of a hydraulic actuator (and vice-versa). When utilized with agricultural implements 10, the first actuator 30 and the second actuator 40 are both preferably hydraulic cylinders though not required to be hydraulic cylinders as discussed herein.

### D. First Actuator

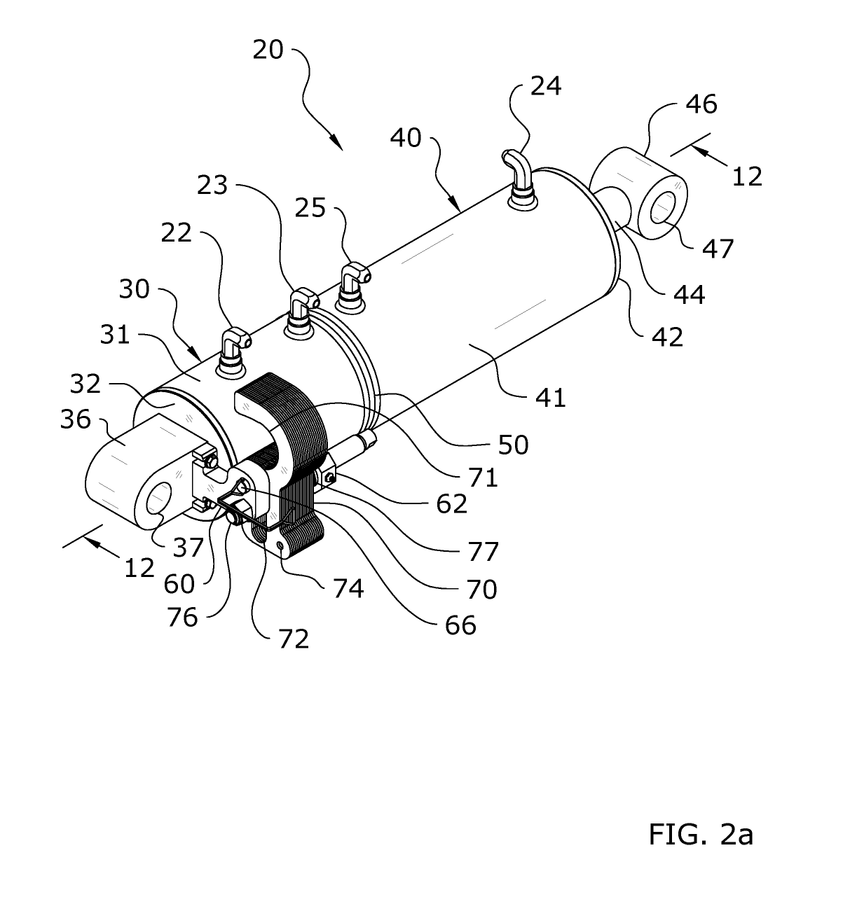

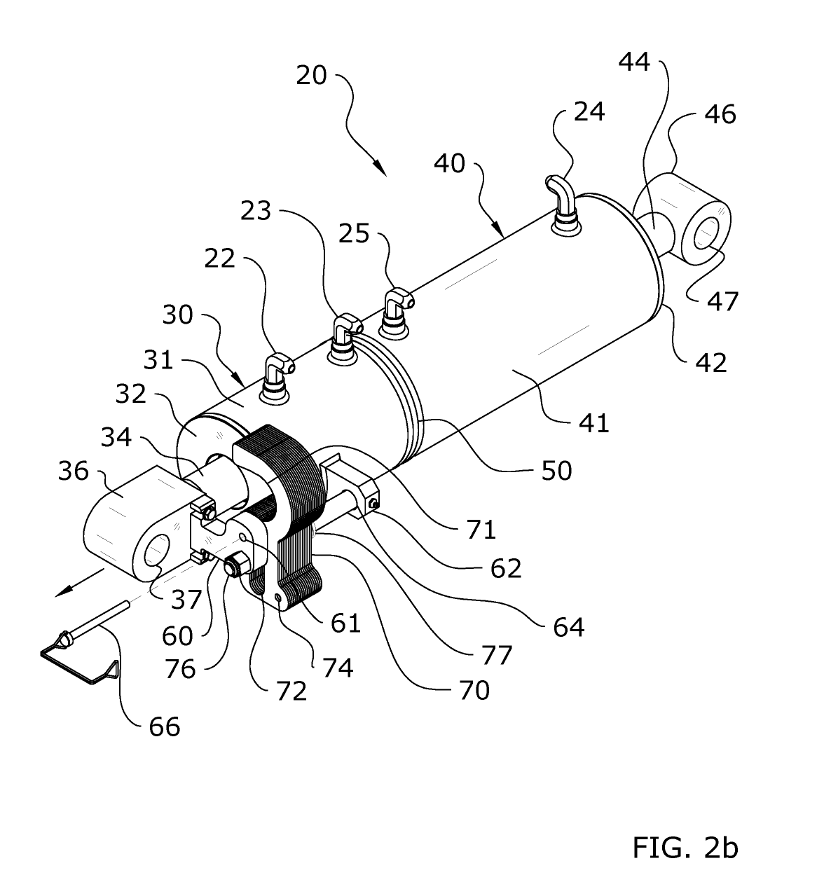

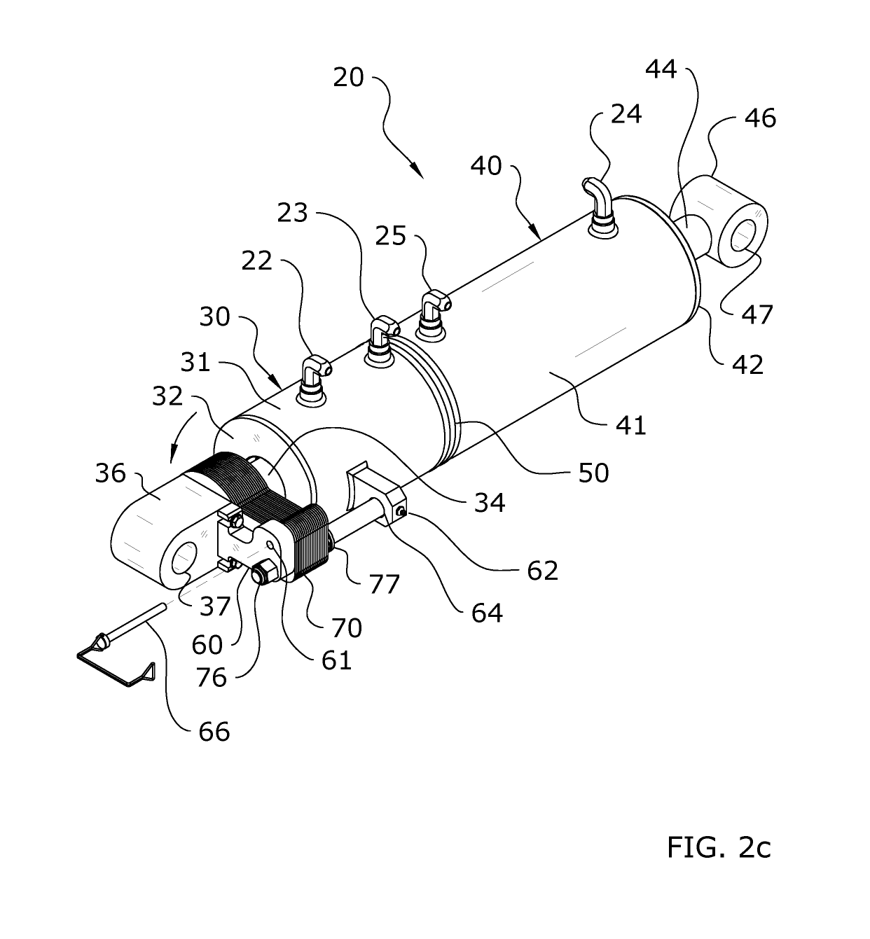

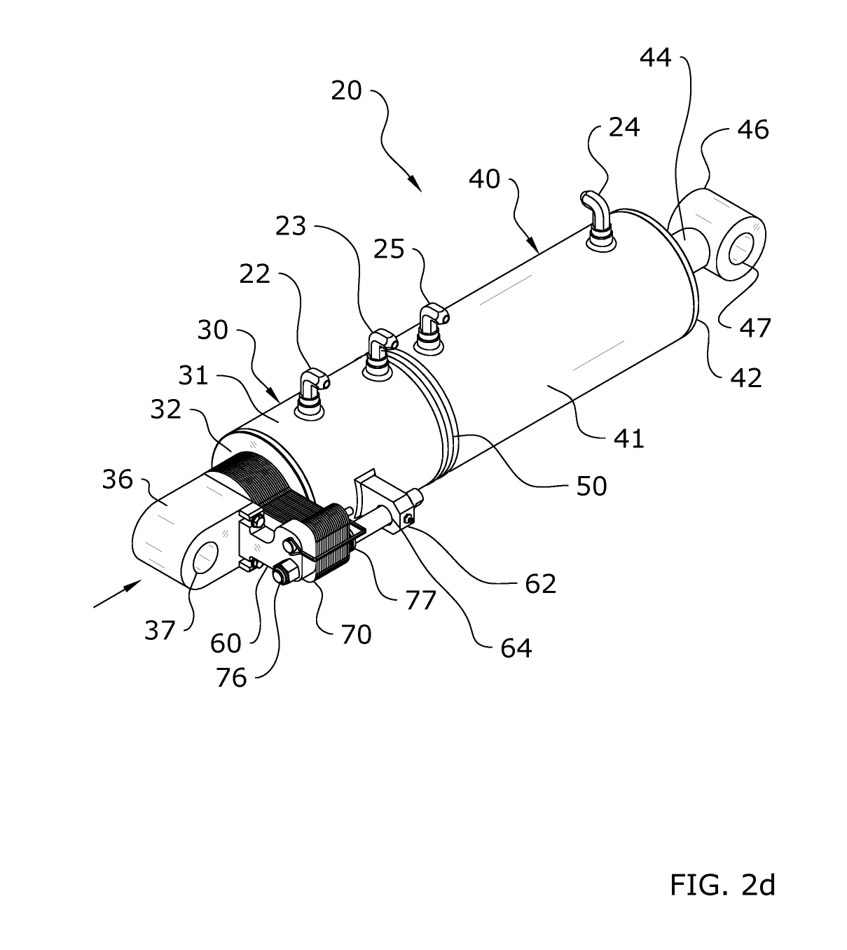

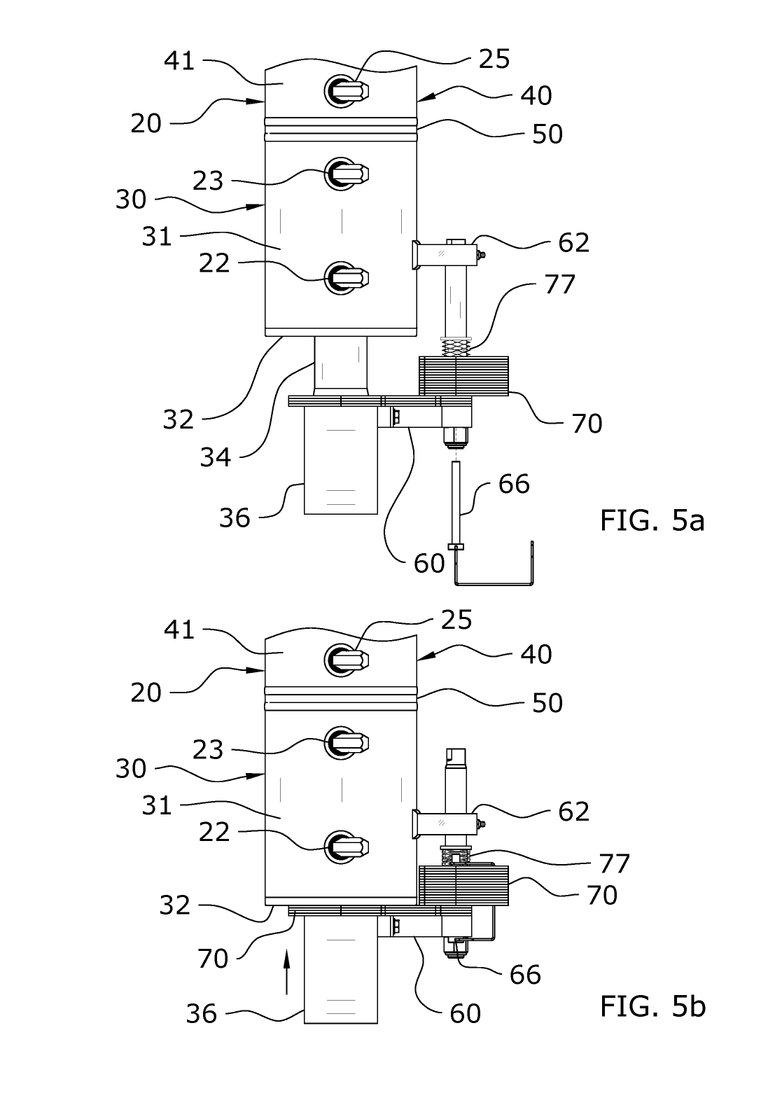

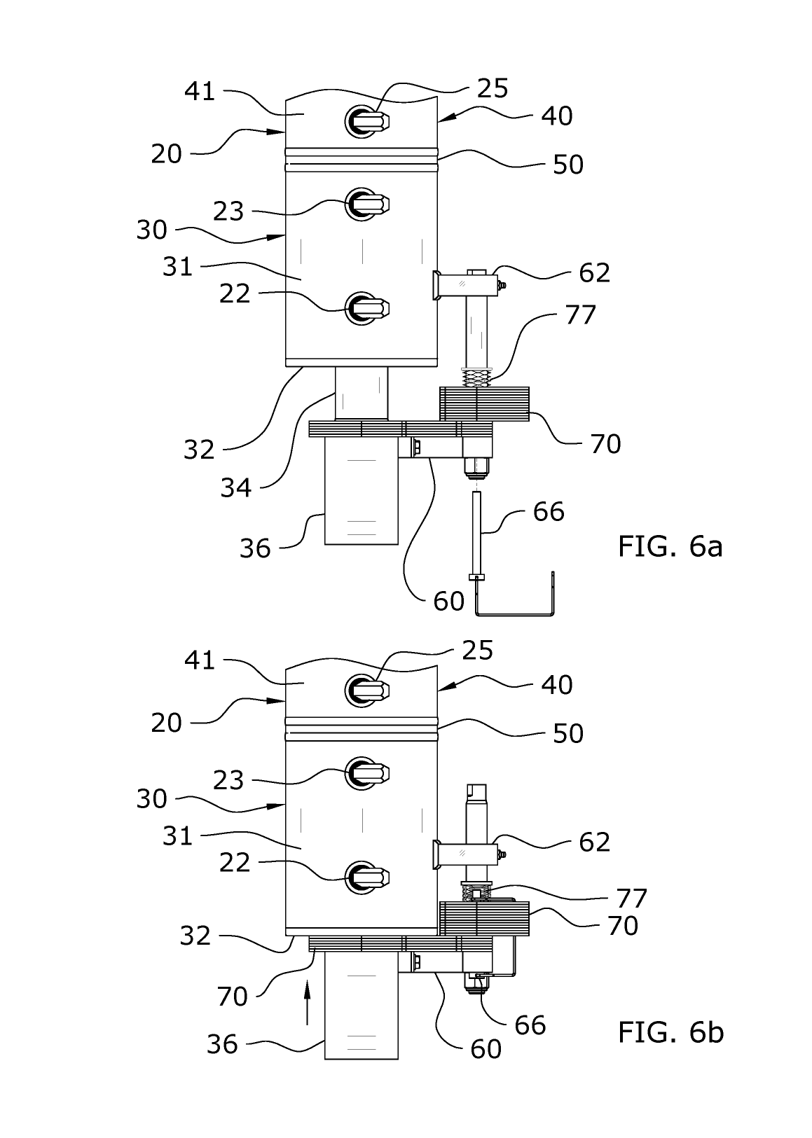

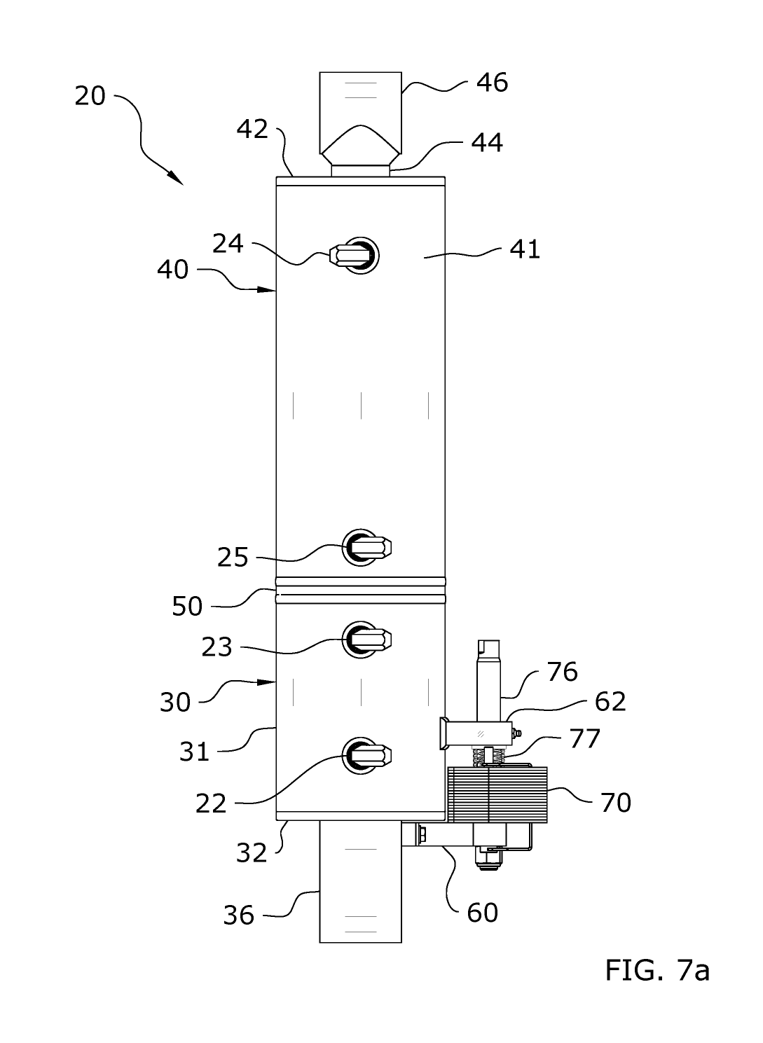

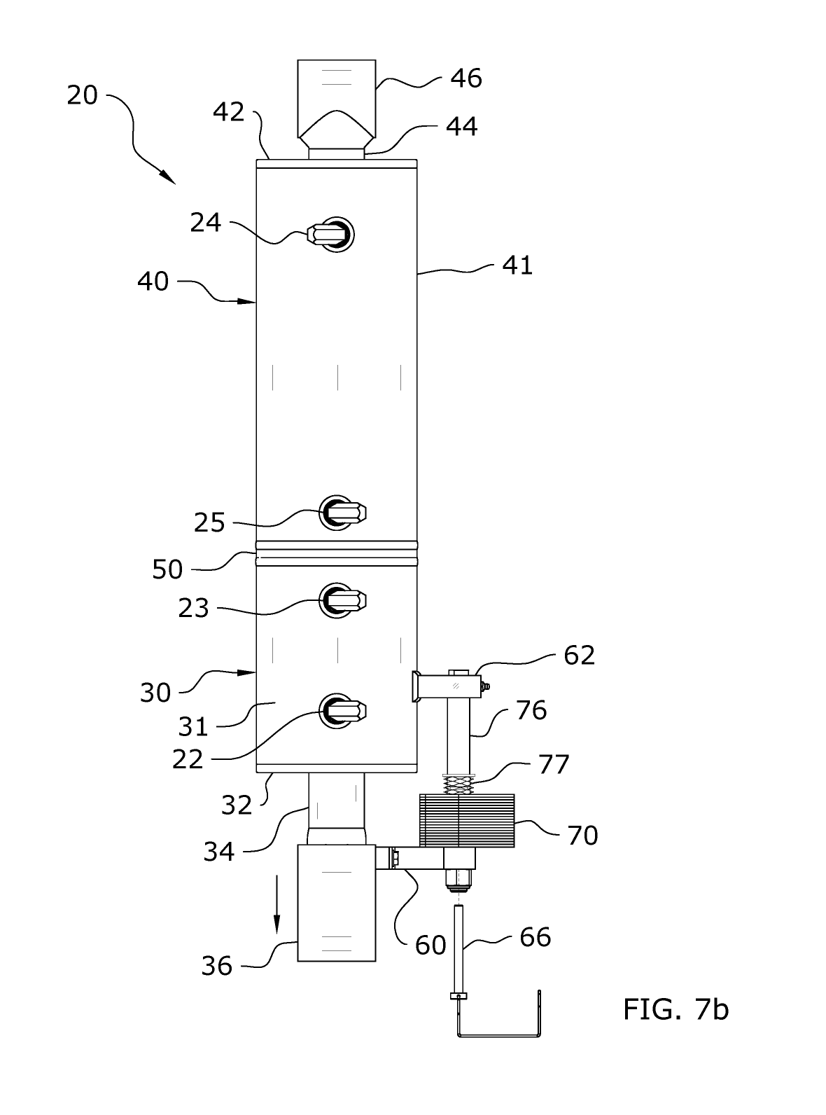

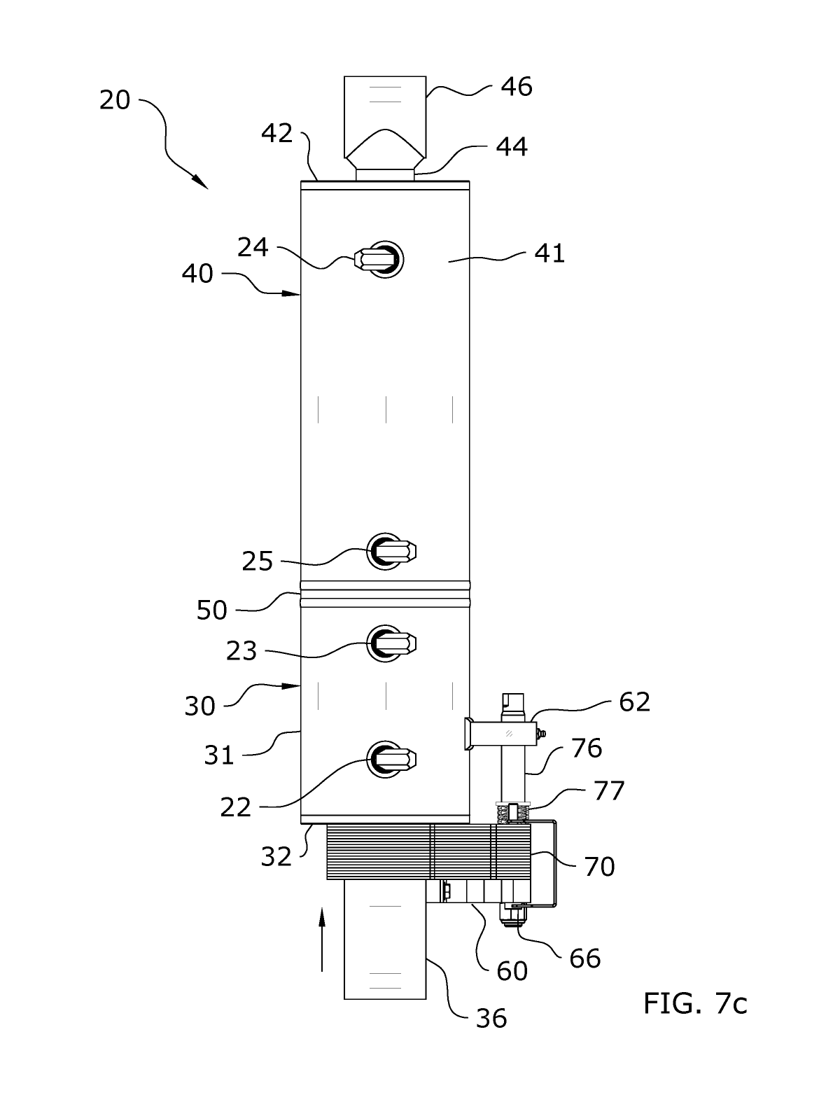

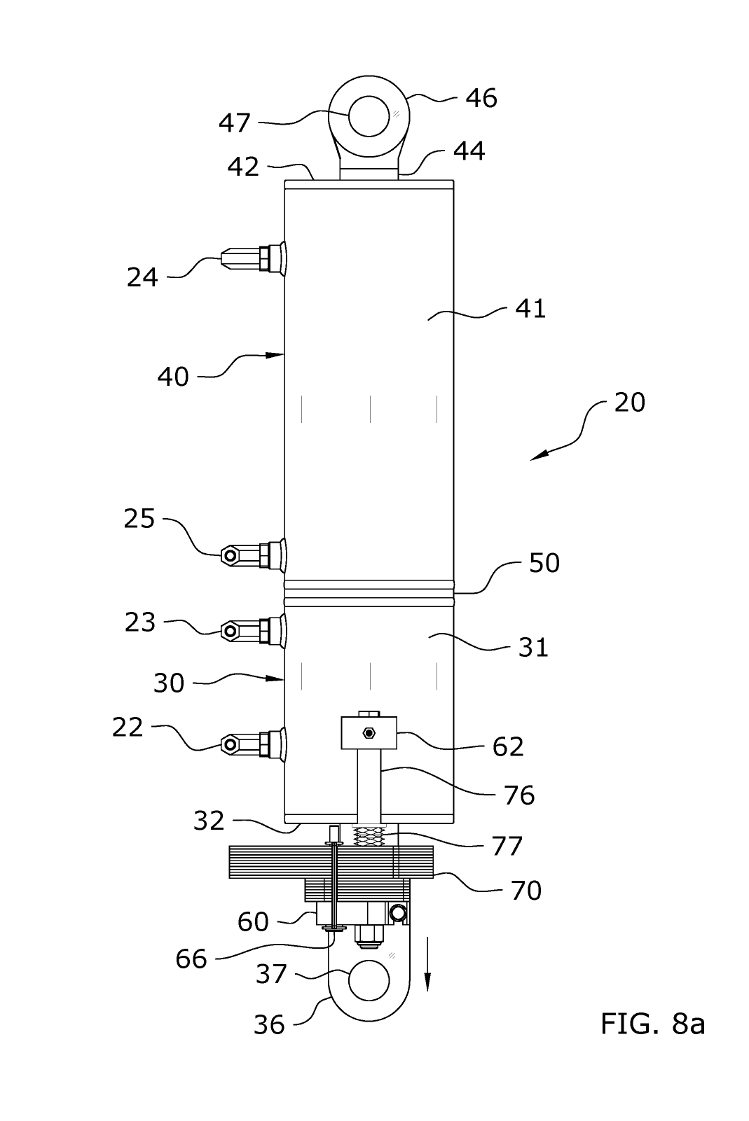

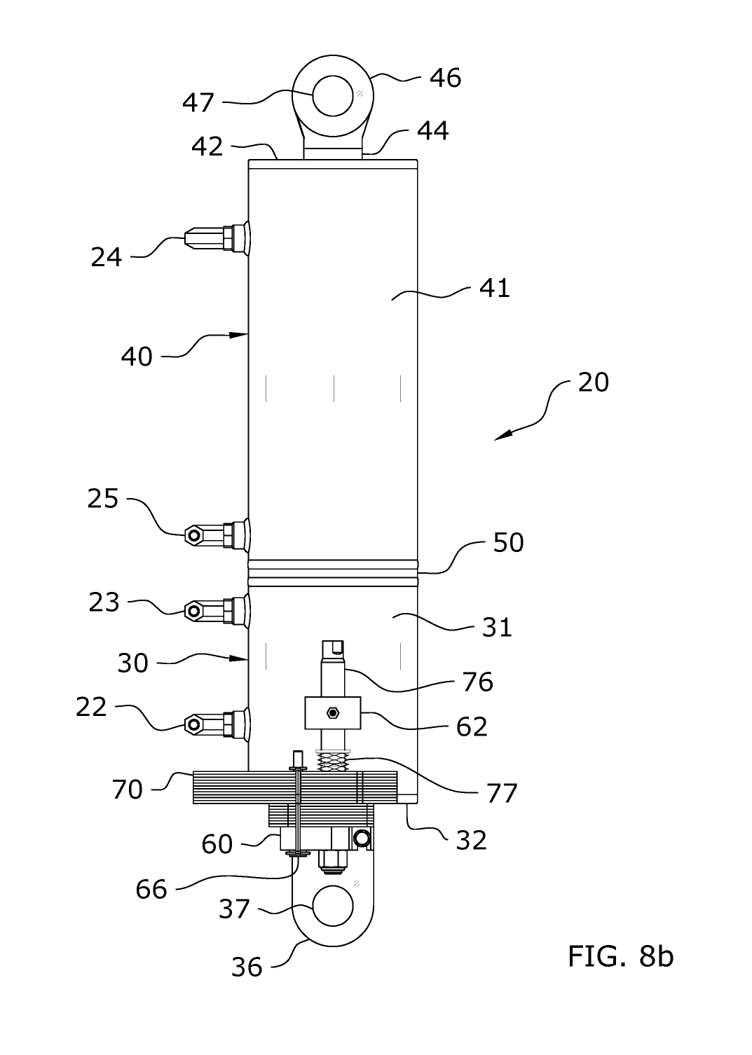

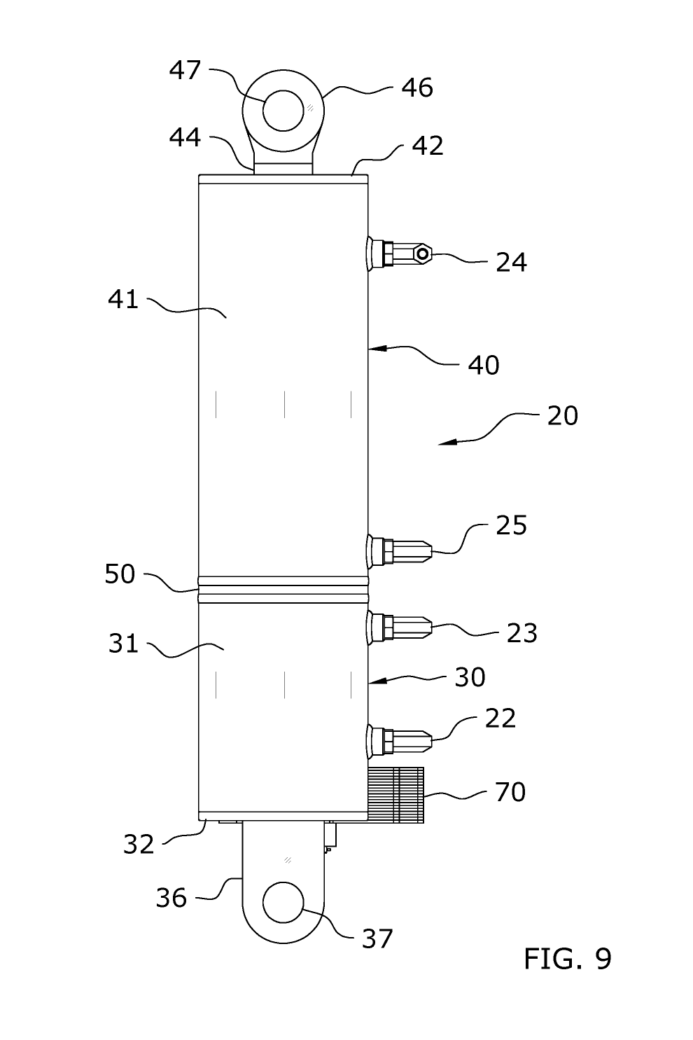

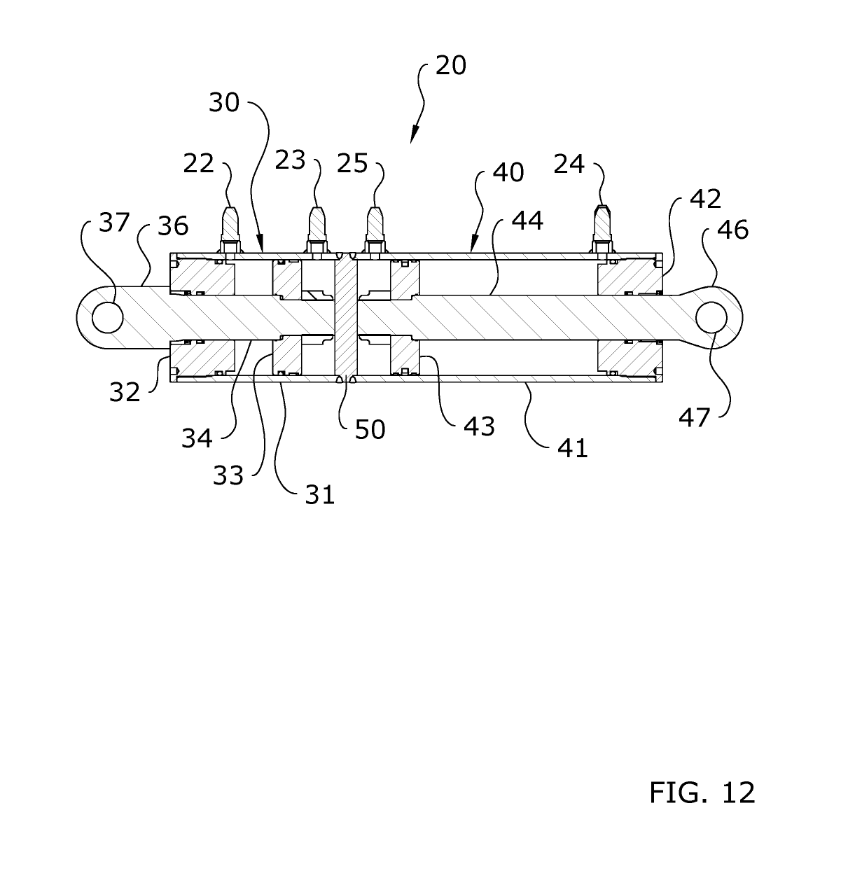

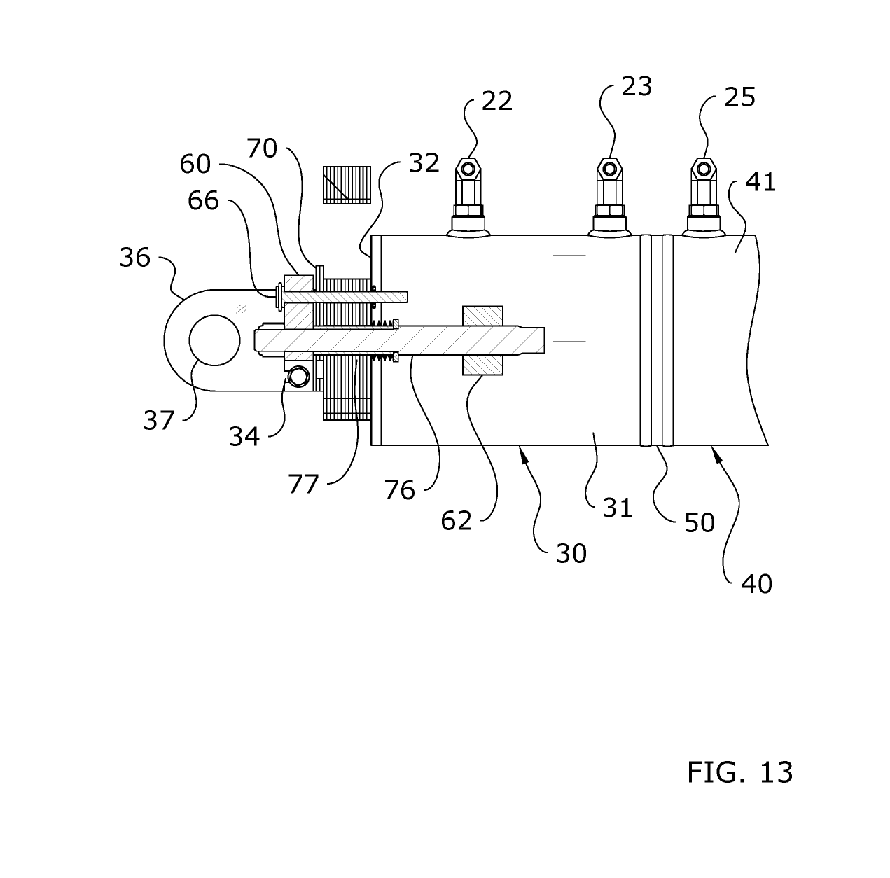

FIGS. 2a through 9 illustrate the first actuator 30. The first actuator 30 includes a first barrel 31 having a first head 32, a first rod 34 movably extending from the first barrel 31 and a first end mount 36 attached to a distal portion of the first rod 34. The first end mount 36 may have various types of connector configurations such as including a first opening 37 to receive a pin for attachment to the implement 10 and/or wheel assembly 17. At least a portion of the first end mount 36 has a width that is greater than the first rod 34 as illustrated in FIG. 12. The first rod 34 is not limited to a solid shaft and may include hollow shafts.

If the first actuator 30 is a hydraulic cylinder as illustrated in FIG. 12, the first actuator 30 further includes a first piston 33 within the first barrel 31 that is connected to the first rod 34 and a pair of fluid ports 22, 23 to receive and eject pressurized hydraulic fluid. As pressurized hydraulic fluid enters the first port 22 (and exits via the second port 23), the first rod 34 is retracted until the first end mount 36 engages the first head 32 or a shim 70 positioned between the first head 32 and the first end mount 36. If the flow of pressurized hydraulic fluid is reversed, the pressurized hydraulic fluid enters the second port 23 (and exits via the first port 22) thereby extending the first rod 34 until the first piston 33 engages the first head 32 or is otherwise prevented from moving further.

### E. Second Actuator

FIGS. 2a through 4b and FIGS. 7a through 9 best illustrate the second actuator 40. The second actuator 40 is utilized to provide the operational movement of the adjustable actuator 20 during normal operation of the implement 10 whereas the first actuator 30 is preferably utilized only temporarily to adjust the minimum length of the adjustable actuator 20.

The second actuator 40 includes a second barrel 41 having a second head 42, a second rod 44 movably extending from the second barrel 41 and a second end mount 46 attached to a distal portion of the second rod 44. The second end mount 46 may have various types of connector configurations such as including a second opening 47 to receive a pin for attachment to the implement 10 and/or wheel assembly 17. At least a portion of the second end mount 46 preferably has a width that is greater than the second rod 44 as illustrated in FIG. 12, however the second end mount 46 may have width less than or equal to the second rod 44. As with the first rod 34, the second rod 44 is not limited to a solid shaft and may include hollow shafts.

If the second actuator 40 is a hydraulic cylinder as illustrated in FIG. 12, the second actuator 40 further includes a second piston 43 within the second barrel 41 that is connected to the second rod 44 and a pair of fluid ports 24, 25 to receive and eject pressurized hydraulic fluid. As pressurized hydraulic fluid enters the third port 24 (and exits via the fourth port 25), the second rod 44 is retracted until the second end mount 46 engages the second head 42. If the flow of pressurized hydraulic fluid is reversed, the pressurized hydraulic fluid enters the fourth port 25 (and exits via the third port 24) thereby extending the second rod 44 until the second piston 43 engages the second head 42 or is otherwise prevented from moving further.

The length of the first actuator 30 and/or the stroke length of the first actuator 30 are preferably less than the second actuator 40 as illustrated in FIG. 12. The length and stroke length of the first actuator 30 is only required to be sufficient to provide an adjustment of the minimum length by a specified range (e.g. 6 inches, 10 inches, etc.) The stroke length of the first actuator 30 is preferably at least as long as the total width of all the shims 70 when all of the shims 70 are in the engaged position on the first rod 34 to provide clearance to move the shims 70 into the engaged position. Having said the above, the lengths and stroke lengths of the first actuator 30 and the second actuator 40 may be the same.

The first actuator 30 and the second actuator 40 are each preferably linear actuators. The first actuator 30 extends the first rod 34 in the first direction and the second actuator 40 extends the second rod 44 in the second direction, wherein it is preferable that the first direction is substantially opposite of the second direction as illustrated in FIG. 12 of the drawings. The first actuator 30 is preferably substantially concentric with the second actuator 40. The first rod 34 is also preferably substantially concentric with the second rod 44. The first rod 34 and the second rod 44 are preferably at least parallel to one another, however, the rods 34, 44 may extend at an angle with respect to one another in a non-parallel manner.

The first actuator 30 is preferably connected to the second actuator 40 in a non-movable manner but may be movably connected. It is preferable that an inner end of the first actuator 30 is connected to an inner end of the second actuator 40 as illustrated in FIGS. 2a through 9 of the drawings. A connector member 50 may be positioned between the first actuator 30 and the second actuator 40 to form an end plate for each of the actuators 30, 40 wherein the inner ends of the actuators 30, 40 are connected to the connector member 50 as illustrated in FIG. 12. The connector member 50 may be constructed of a plate structure or other type of connecting structure.

However, the first actuator 30 (and first rod 34) may be offset with respect to the second actuator 40 (and second rod 44). For example, the first actuator 30 may be attached to a side of the second actuator 40 with the rods 34, 44 each having a different longitudinal axis which may be parallel or not parallel to one another.

### F. Flow Control Valve

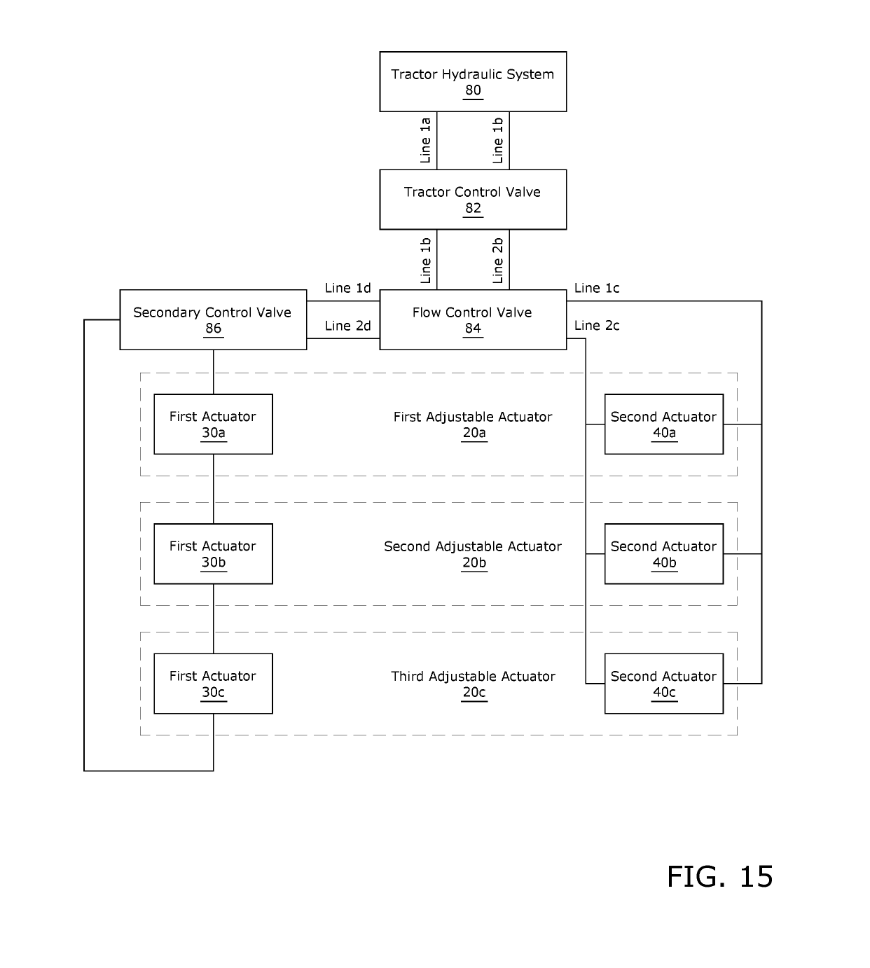

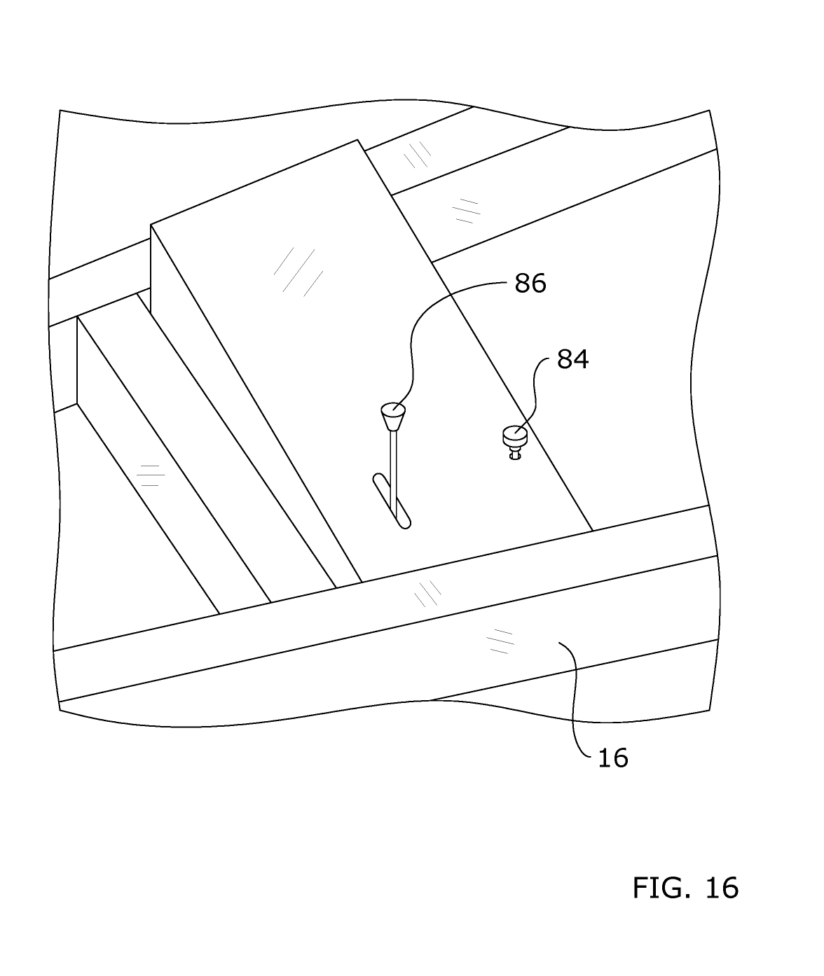

FIGS. 15 and 16 illustrate a flow control valve 84 that is utilized to direct pressurized hydraulic fluid from the tractor's hydraulic system 80 to either the first actuators 30 or the second actuators 40. If the flow control valve 84 is in a first position, the hydraulic fluid is directed towards the first actuators 30 to control the stroke position of the first actuators 30 and if the flow control valve 84 is in a second position, the hydraulic fluid is directed towards the second actuators 40 to control the stroke position of the second actuators 40. While not required, the usage of the flow control valve 84 allows for temporary control and adjustment of the first actuators 30 without having to use a separate set of hydraulic ports (and valves) on the tractor. Alternatively the first actuators 30 can be fluidly connected to and controlled by a first hydraulic circuit on the tractor and the second actuators 40 can be fluidly connected to and controlled by a second hydraulic circuit on the tractor. FIG. 16 illustrates the first actuators 30 fluidly connected in series and the second actuators 40 fluidly connected in parallel with respect to the flow control valve 84. It can be appreciate the first actuators 30 may also be fluidly connected in parallel or the second actuators 40 may also be fluidly connected in series.

The flow control valve 84 is preferably connected to the frame of the implement 10, such as on the hitch 16 of the implement 10, to allow for control of the stroke of the first actuators 30 outside the cab of the tractor and near the first actuators 30 to allow for efficient adjustment of the shims 70. The flow control valve 84 is not part of the valve system of the tractor. To utilize the flow control valve 84 outside of the cab of the tractor, the operator locks the tractor control valve 82 of the hydraulic system 80 into a constant flow position where pressurized fluid is constantly provided by the hydraulic system 80 to the flow control valve 84. By manipulating the flow control valve 84, the operator is able to control whether the hydraulic fluid flows to the first actuators 30 or the second actuators 40. Though not required, a secondary control valve 86 may be fluidly connected between the flow control valve 84 and the first actuators 30 to allow for adjustment of the direction and flowrate of the hydraulic fluid to the first actuators 30 to control the extension and retraction of the first actuators 30.

### G. Shim Structure

FIGS. 2a through 9 best illustrate the shim structure connected to the first actuator 30 to adjust the minimum length of the first actuator 30 and therefore the minimum length of the adjustable actuator 20. While the shim structure is illustrated only attached to the first actuator 30, another similar shim structure may be attached to the second actuator 40 to control the minimum length of the second actuator 40.

A support member 76 is connected to the first actuator 30 directly or via a first bracket 60. The support member 76 may be connected to the first end mount 36 and/or the first barrel 31 of the first actuator 30. In one preferred embodiment, the support member 76 is non-movably connected to the first end mount 36 by a first bracket 60 and is movably connected the first barrel 31 (or first head 32) by a second bracket 62 having a guide opening 64 that slidably receives the support member 76. The illustrated configuration for the support member 76 may be reversed so that the support member 76 is non-movably connected to the first barrel 31 (or first head 32) and is movably connected to the first end mount 36. It can be appreciated that a second bracket 62 is not required to movably support the support member 76. The support member 76 is preferably comprised of a rod structure (solid or hollow), but may be comprised of other types of structures capable of supporting the plurality of shims 70.

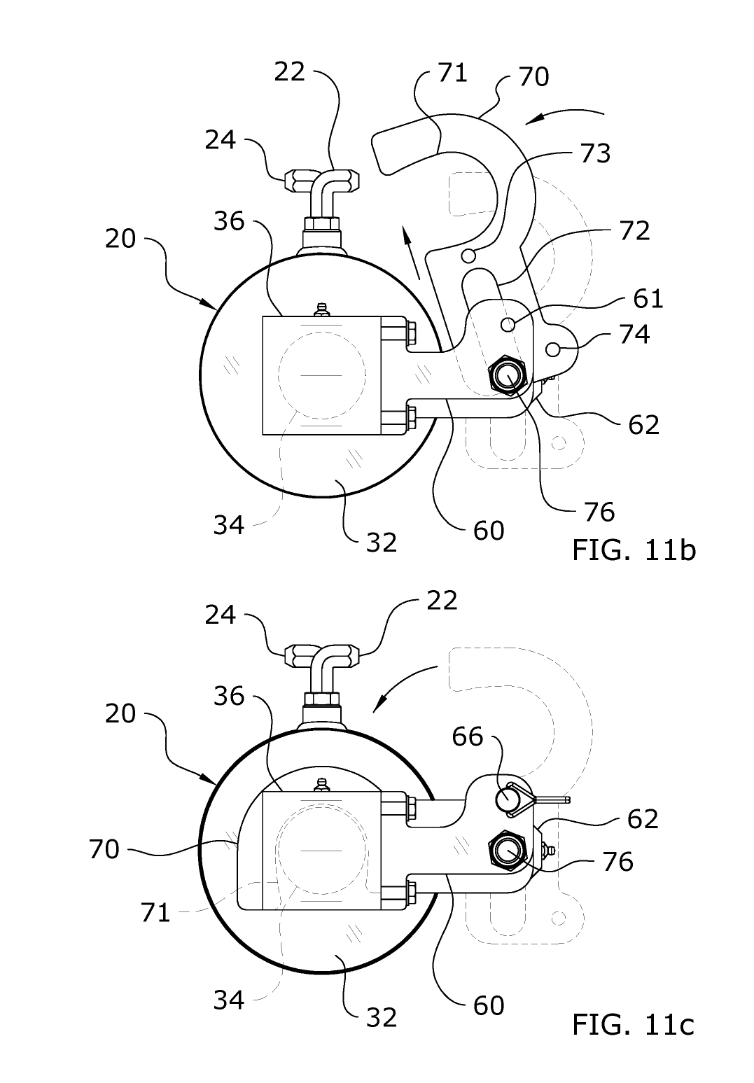

FIGS. 2a through 9 illustrate a plurality of shims 70 movably connected to the support member 76. The shims 70 are preferably pivotally connected to the support member 76 about a common axis, however, the shims 70 may be movably connected in other manners. The shims 70 further preferably include a slot 72 that allows for the shims 70 to be movably positioned about the support member 76 such that the shims 70 may both pivot about the support member 76 and move along a longitudinal axis of the slot 72 as best illustrated in FIG. 11b of the drawings.

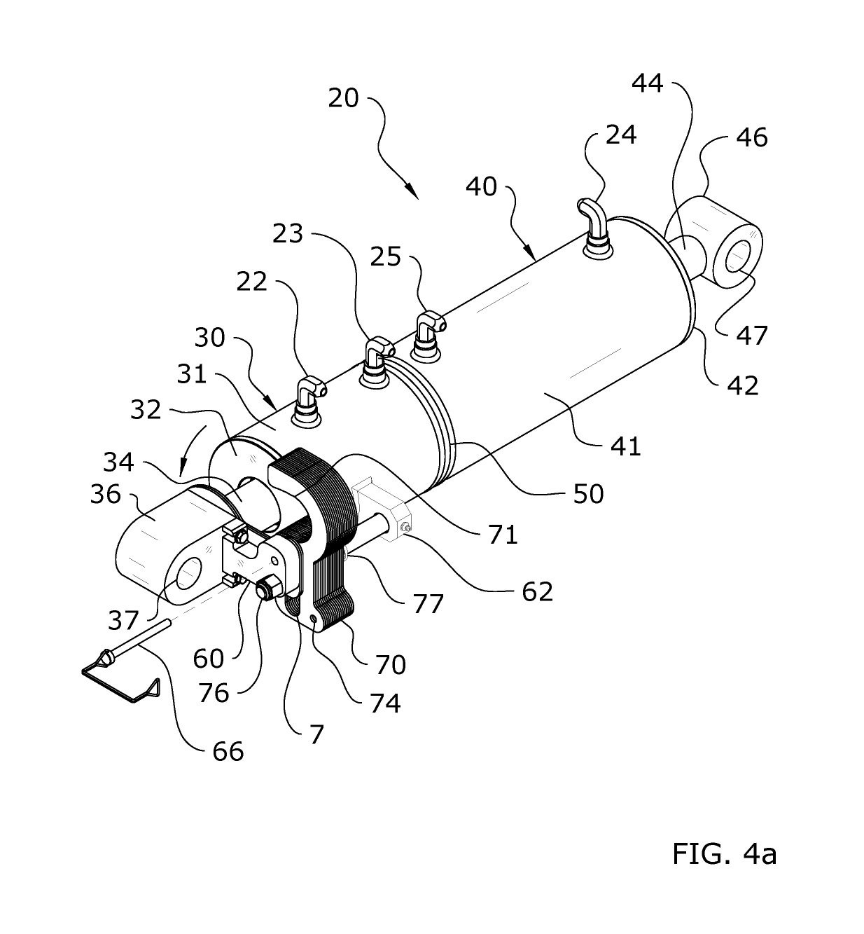

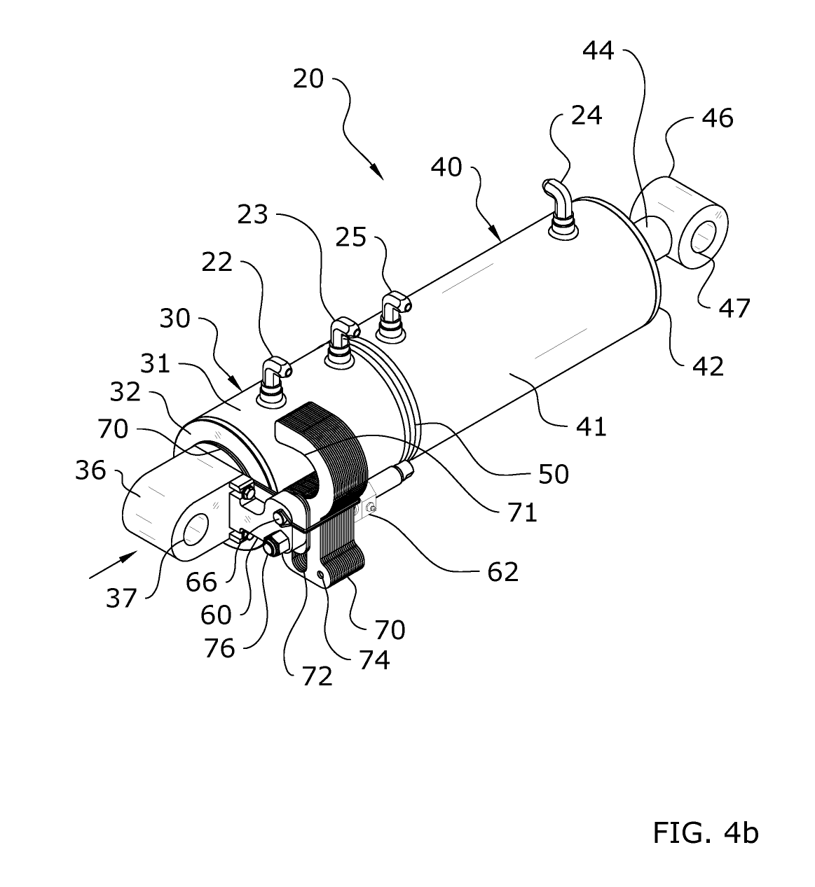

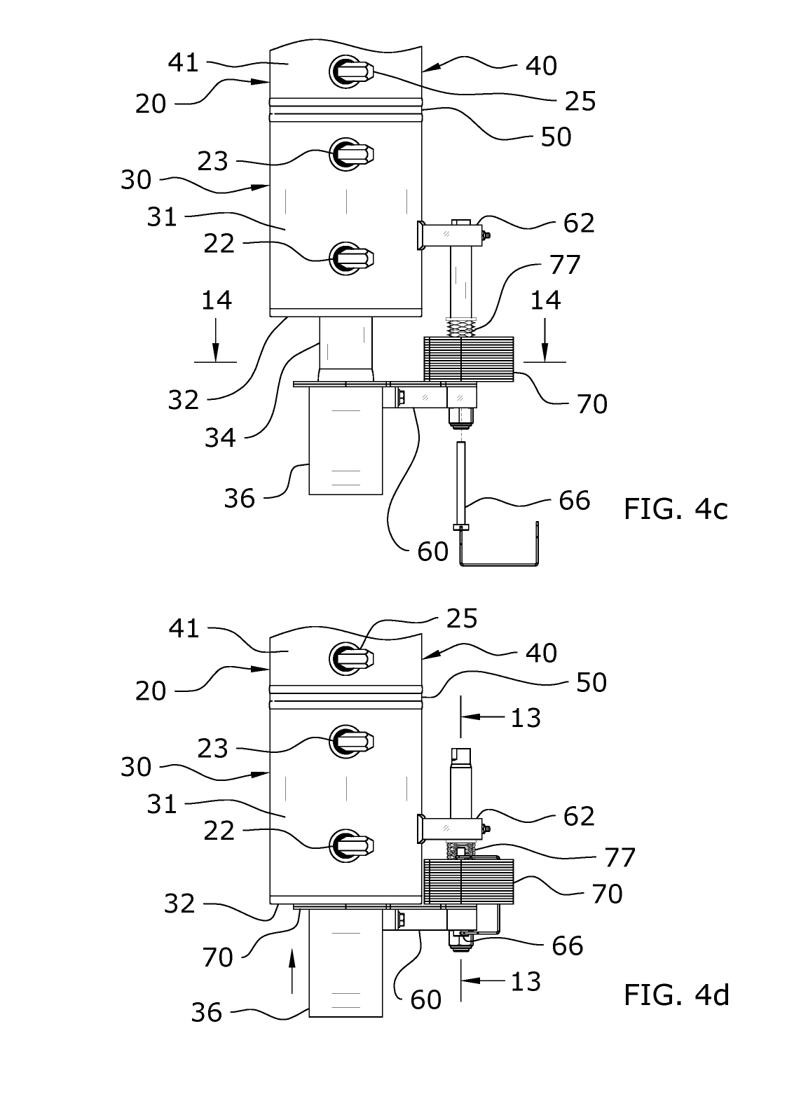

At least one spring 77 (e.g. compression spring) is preferably attached to the support member 76 that applies a biasing force against the shims 70 to keep the shims 70 together and adjacent the first bracket 60 as best illustrated in FIG. 4c of the drawings. The spring 77 is illustrated in FIG. 4c as surrounding the support member 76 along with a clip attached to the support member 76 holding one side of the spring 77 opposite of the shims 70, however, various other configurations of biasing devices may be used to apply a biasing force to the shims 70.

The shims 70 are movable between a storage position offset from the first rod 34 and an engaged position engaging the first rod 34 between the first head 32 and the first end mount 36. The shims 70 are preferably aligned transversely with respect to a longitudinal axis of the first rod 34. The support member 76 is preferably parallel with respect to the first rod 34 but may be positioned at an angle with respect to the first rod 34.

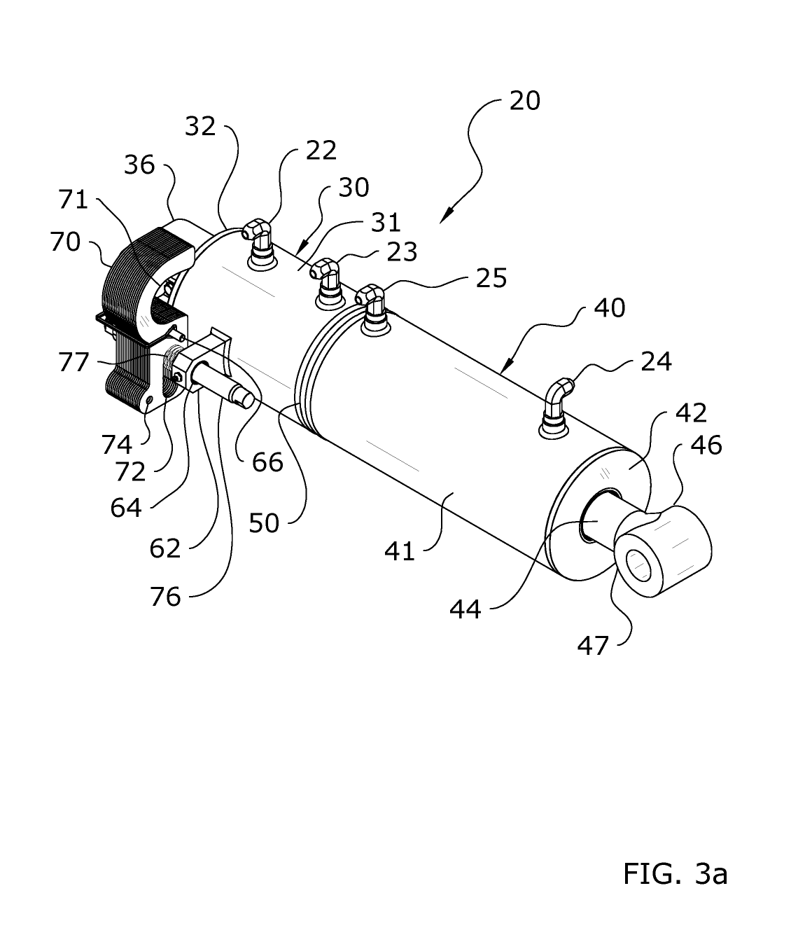

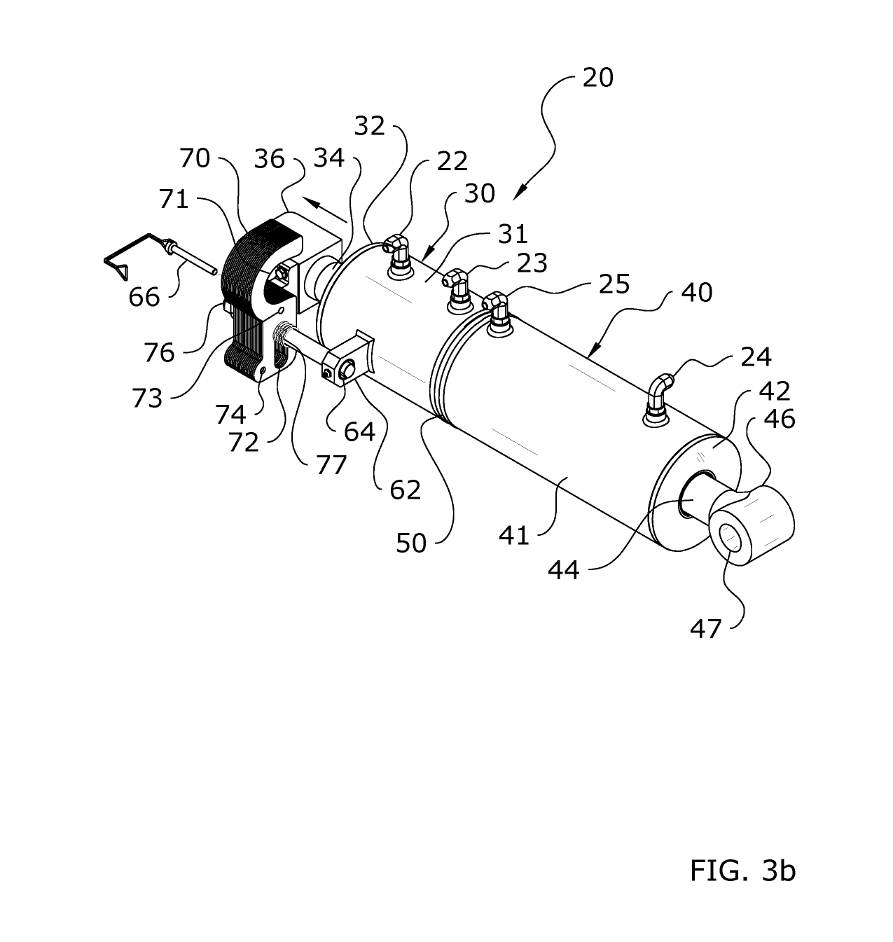

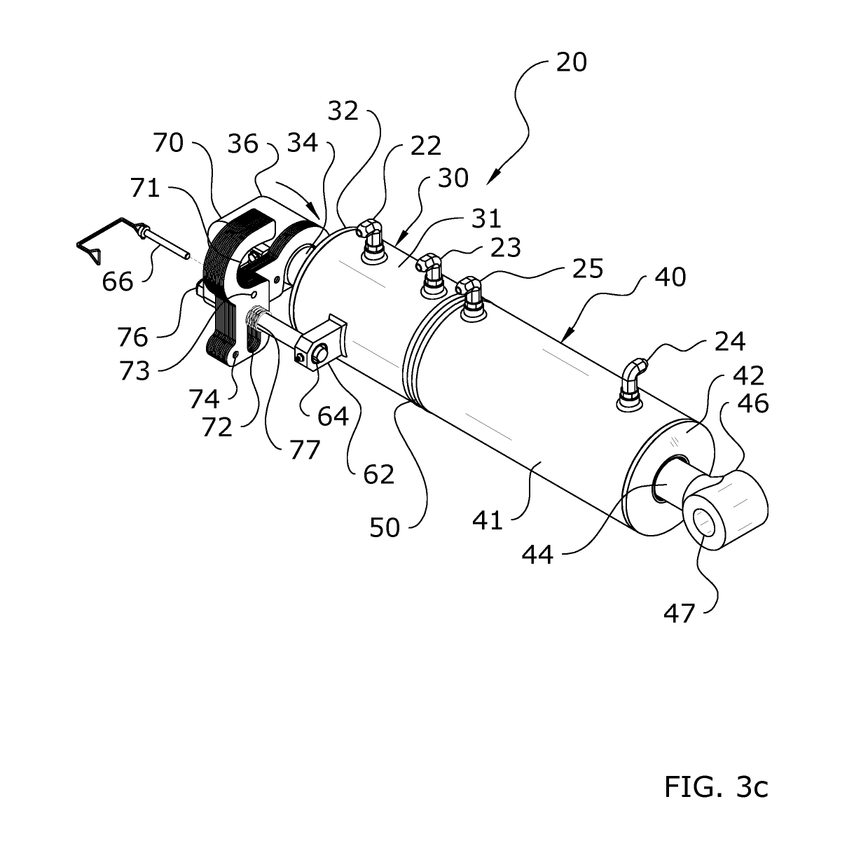

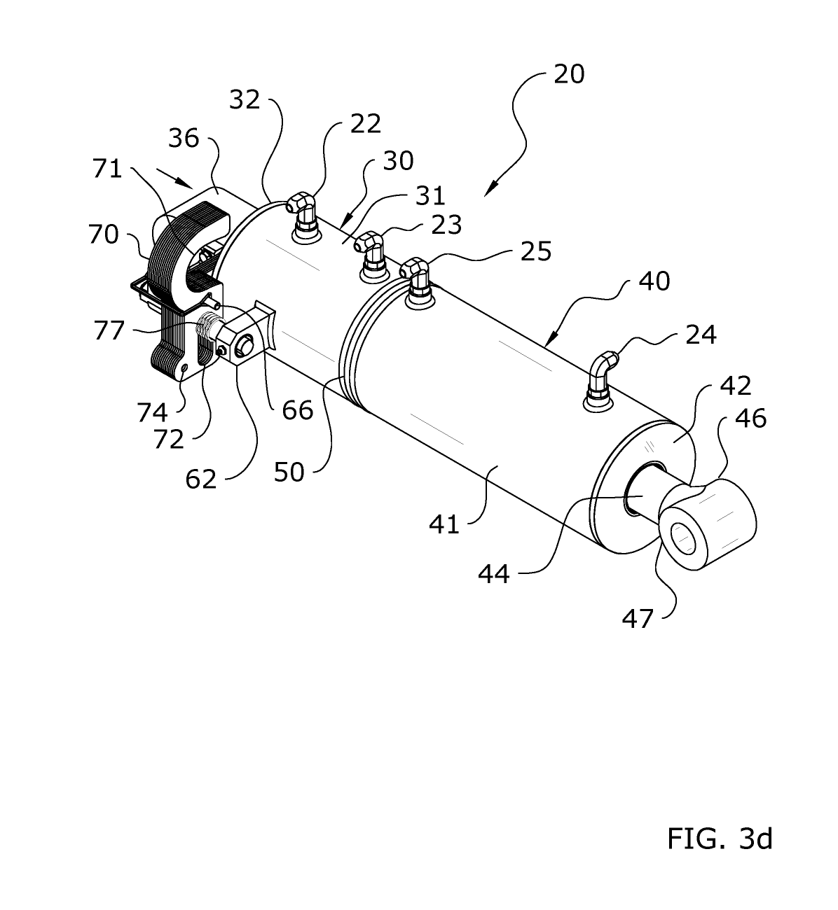

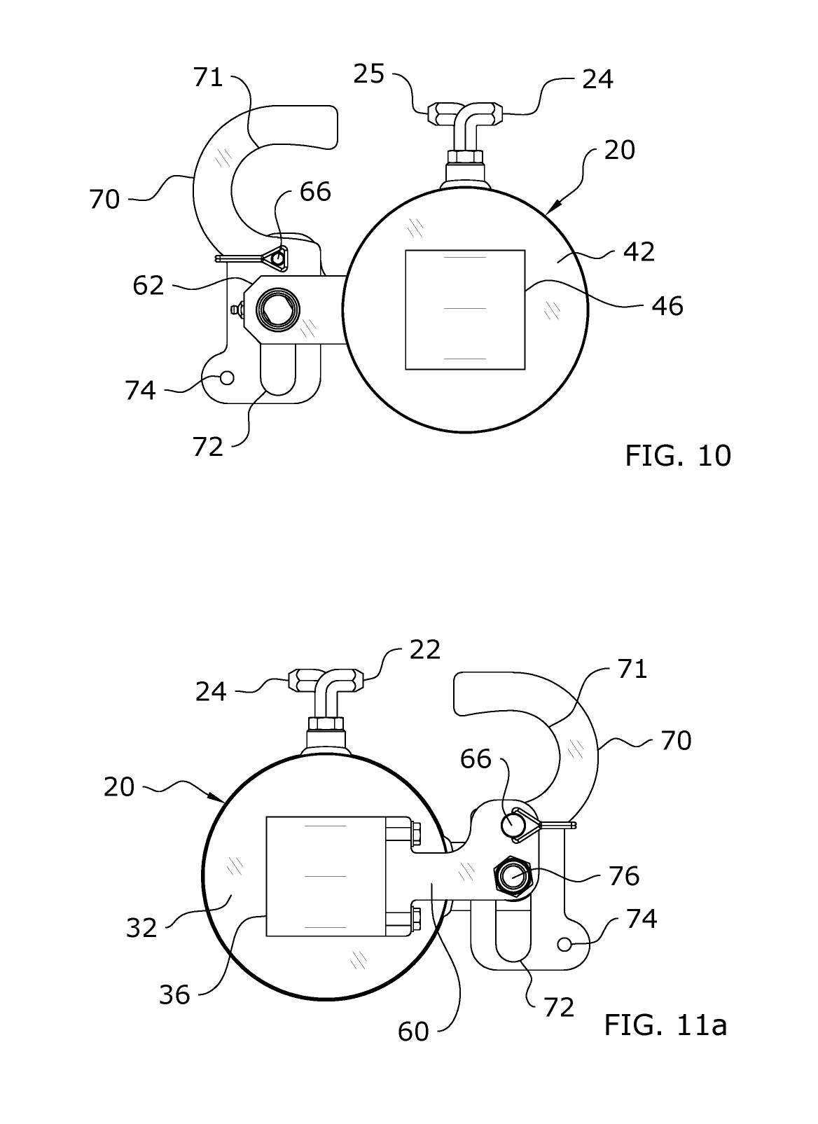

The storage position for the shims 70 is best illustrated in FIGS. 2a, 3a and 10 of the drawings. As illustrated, when the shims 70 are in the storage position the shims 70 are not positioned between the first end mount 36 and the first head 32 of the first actuator 30. The engaged position for the shims 70 is best illustrated in FIGS. 2c, 2d, 3c and 3d of the drawings. As illustrated, when the shims 70 are in the engaged position, the shims 70 are positioned between the first end mount 36 and the first head 32 of the first actuator 30 to limit the retraction of the first rod 34 by a length approximately equal to the total width of all the shims 70 in the engaged position.

The shims 70 are each comprised of a substantially flat structure and are positioned side-by-side one another. The shims 70 preferably each have the same thickness (e.g. 1 mm), however, the shims 70 may have varying thicknesses (e.g. the shims 70 closest to the first end mount 36 may be thinner than the shims 70 further away from the first end mount 36 and vice versa). The shims 70 are comprised of a rigid material such as, but not limited to, metal. The shims 70 further preferably all have the same shape and size as illustrated in the drawings, however, the shims 70 may have different shapes and sizes.

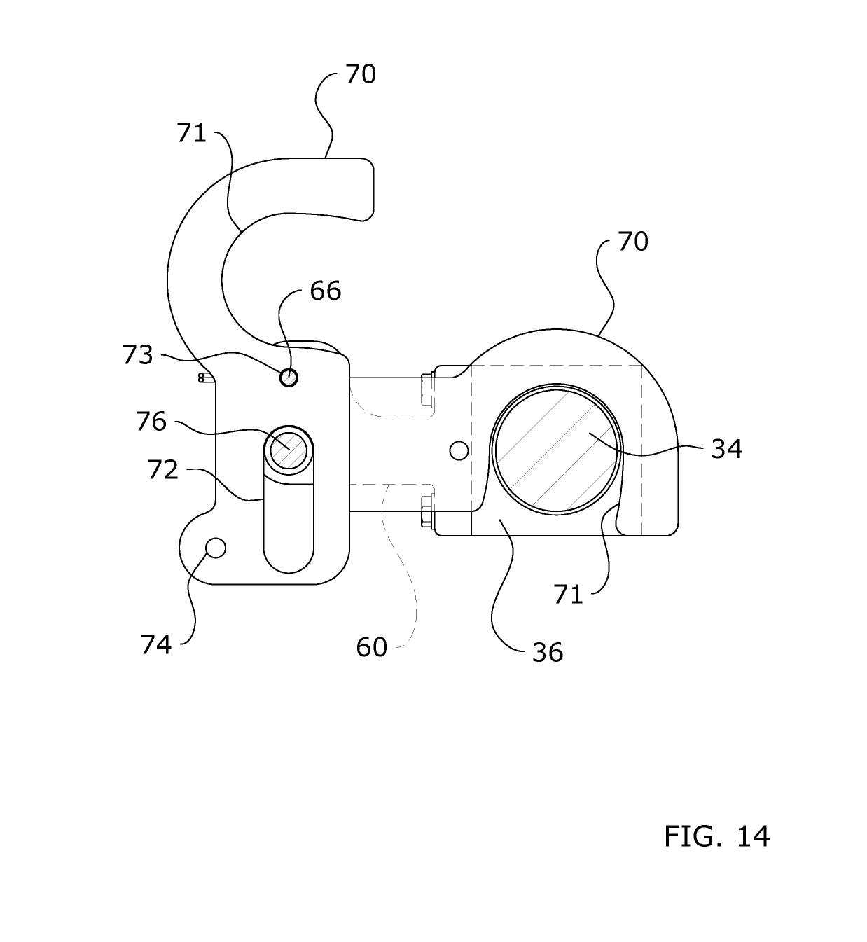

The shims 70 have a body portion and an engaging portion. The body portion is movably connected to the support member 76 and the engaging portion extends outwardly from the body portion to selectively engage the first rod 34 along with being positionable between the first end mount 36 and the first head 32. The shims 70 each include a cutout 71 within the engaging portion so that the engaging portion is adapted to fit about a portion of the first rod 34 when in the engaged position as illustrated in FIG. 14 of the drawings. The engaging portion of the shims 70 preferably has a C-shaped configuration that is formed to fit about an upper portion of the first rod 34 as shown in FIG. 14. It is preferable that the inner and outer portions of the engaging portion of the shims 70 extend at least to or beyond the lower portion of the first rod 34 as further shown in FIG. 14 to increase the surface area of engagement of the shims 70 between the first end mount 36 and the first head 32.

The first bracket 60 preferably includes a locking aperture 61 as illustrated in FIGS. 2a and 2b of the drawings. The shims 70 each include a first aperture 73 as best shown in FIG. 14 of the drawings. The first aperture 73 of a selected shim(s) 70 is aligned with the locking aperture 61 of the first bracket 60 when the selected shim(s) 70 is positioned in the storage position to removably receive a locking member 66 (e.g. a pin, wire lock pin, snapper pin, safety spring pin, etc.) within the locking aperture 61 and the first aperture 73 to prevent the selected shim(s) 70 from moving out of the storage position.

The shims 70 also preferably each include a second aperture 74 as illustrated in FIGS. 2a, 3a and 14 of the drawings. The second aperture 74 of a selected shim(s) 70 is aligned with the locking aperture 61 of the first bracket 60 when the selected shim(s) 70 is position in the engaged position to removably receive the locking member 66 within the locking aperture 61 and the second aperture 74 to prevent the selected shim(s) 70 from moving out of the engaged position.

### H. Operation of Preferred Embodiment

In use of one of the preferred embodiments, the operator of a tractor pulling an agricultural implement 10 such as a fertilizer applicator determines which portions of the frame of the implement 10 need to be higher (or lower) to level the implement 10. Leveling the implement 10 ensures that all of the working units (e.g. fertilizer knives) of the implement 10 that engage the ground surface penetrate the ground surface at approximately the same depth so that a fertilizer or other material may be applied at a consistent depth throughout the entire implement 10. As an example, if a portion of the implement 10 is too low with the working units penetrating the soil at too great of a depth, the operator will determine the number of shims 70 that need to be additionally positioned in the engaged position on the corresponding adjustable actuator 20. In further of the example, if a portion of the implement 10 is too high with the working units penetrating the soil at too shallow of a depth, the operator will determine the number of shims 70 that need to be removed from the engaged position on the corresponding adjustable actuator 20.

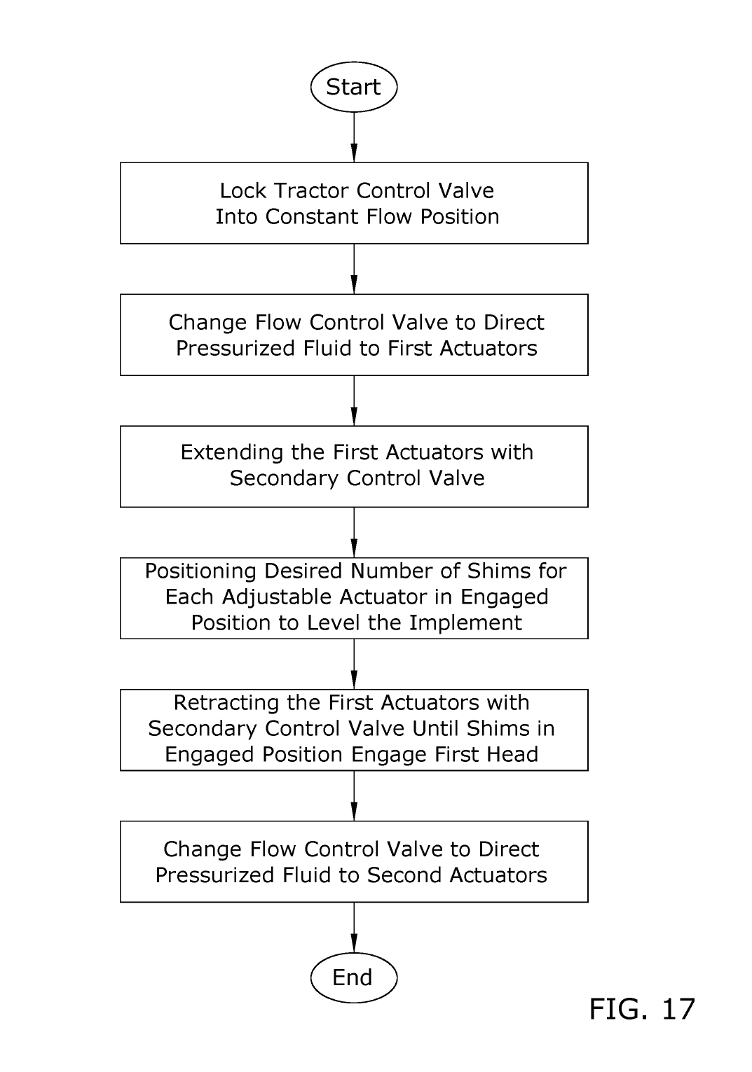

After determining the adjustments that need to be made to the minimum length of the adjustable actuators 20 on the implement 10, the operator locks the tractor control valve 82 into the constant flow position as shown in FIG. 17. The operator then changes the flow control valve 84 to direct the pressurized hydraulic fluid to the first actuators 30 and then controls the extension of the first actuators 30 with the secondary control valve 86. After the first actuators 30 are extended sufficiently, the operator then removes the locking member 66 from the shims 70 and then changes the position of the shims 70 so that a desired number of shims 70 are in the engaged position and the remaining shims 70 are in the storage position for each of the adjustable actuators 20. For example, the total number of shims 70 in the engaged position on the adjustable actuator 20 determines the total length adjustment of the minimum length of the adjustable actuator 20. Once the shims 70 are properly selected, the user then extends the locking member 66 through the locking aperture 61 of the first bracket 60 and then through the second apertures 74 of the shims 70 that are in the engaged position and then through the first apertures 73 of the shims 70 that are in the storage position followed by locking of the locking member 66 using a locking mechanism (e.g. spring clamp) to prevent removal thereof. The user then retracts the first actuators 30 using the secondary control valve 86 until all of the first actuators 30 are retracted with the first end mount 36 abutting the shims 70 in the engaged position as shown in FIGS. 2d and 3d. The operator verifies that the implement 10 is properly leveled and may repeat the above process if any further leveling of the implement 10 is required to ensure that all of the working units are operating at the same depth when the second actuators 40 are fully retracted.

Unless otherwise defined, all technical and scientific terms used herein have the same meaning as commonly understood by one of ordinary skill in the art to which this invention belongs. Although methods and materials similar to or equivalent to those described herein can be used in the practice or testing of the implement leveling system, suitable methods and materials are described above. All publications, patent applications, patents, and other references mentioned herein are incorporated by reference in their entirety to the extent allowed by applicable law and regulations. The implement leveling system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. An agricultural implement, comprising:
a frame; and
a plurality of wheel assemblies connected to the frame, wherein the wheel assemblies each include a wheel and an adjustable actuator, wherein the adjustable actuator is adapted for lifting and lowering a corresponding wheel assembly;
wherein the adjustable actuator has a minimum length that is adjustable, wherein the adjustable actuator includes:
a first actuator extending in a first direction, wherein the first actuator includes a first barrel having a first head, a first rod movably extending from the first barrel and a first end mount attached to a distal portion of the first rod;
a support member connected to the first actuator;
a plurality of shims movably connected to the support member, wherein the shims are movable between a storage position offset from the first rod and an engaging position engaging the first rod between the first head and the first end mount, wherein a selected number of shims in the engaged position determines the minimum length; and
a second actuator extending in a second direction, wherein the second actuator includes a second barrel having a second head, a second rod movably extending from the second barrel and a second end mount attached to a distal portion of the second rod;
wherein the first actuator and the second actuator are each linear actuators.

2. The agricultural implement of claim 1, wherein the frame is comprised of a central frame, a first wing frame movably connected to the central frame and a second wing frame movably connected to the central frame opposite of the first wing frame.

3. The agricultural implement of claim 1, wherein the implement is comprised of a fertilizer applicator having a plurality of fertilizer application units extending downwardly from the frame adapted to apply fertilizer to the ground.

4. The agricultural implement of claim 1, wherein the first actuator is substantially concentric with the second actuator.

5. The agricultural implement of claim 1, wherein the first direction is substantially opposite of the second direction.

6. The agricultural implement of claim 1, wherein the second actuator is comprised of a hydraulic cylinder.

7. The agricultural implement of claim 6, wherein the first actuator is comprised of a hydraulic cylinder.

8. The agricultural implement of claim 1, wherein the first actuator is connected to the second actuator in a non-movable manner.

9. The agricultural implement of claim 1, wherein an inner end of the first actuator is connected to an inner end of the second actuator.

10. The agricultural implement of claim 1, including a connector member, wherein an inner end of the first actuator is connected to the connector member and an inner end of the second actuator is connected to the connector member.

11. The agricultural implement of claim 10, wherein the connector member is a plate structure.

12. The agricultural implement of claim 1, wherein the shims are pivotally connected to the support member.

13. The agricultural implement of claim 1, wherein the shims are each comprised of a substantially flat structure and are positioned side-by-side one another.

14. The agricultural implement of claim 1, wherein the shims are aligned transversely with respect to a longitudinal axis of the first rod.

15. The agricultural implement of claim 1, wherein the shims each include a cutout adapted to fit about a portion of the first rod when in the engaged position.

16. The agricultural implement of claim 1, wherein the shims each include a C-shaped portion that is adapted to fit about a portion of the first rod when in the engaged position.

17. The agricultural implement of claim 1, including a first bracket attached to the first end mount, wherein the support member extends from the first bracket.

18. The agricultural implement of claim 17, including a locking member, wherein the first bracket includes a locking aperture and the shims each include a first aperture, wherein the first aperture of a selected shim is aligned with the locking aperture when the selected shim is positioned in the storage position to removably receive the locking member within the locking aperture and the first aperture to prevent the selected shim from moving out of the storage position.

19. The agricultural implement of claim 18, wherein the shims each include a second aperture, wherein the second aperture of the selected shim is aligned with the locking aperture when the selected shim is position in the engaged position to removably receive the locking member within the locking aperture and the second aperture to prevent the selected shim from moving out of the engaged position.

20. The agricultural implement of claim 1, including a flow control valve connected to the frame, wherein the flow control valve is fluidly connected to the first actuator and the second actuator for each of the wheel assemblies, wherein the flow control valve is adapted to be fluidly connected to a hydraulic system of a tractor, wherein the flow control valve is adapted to direct pressurized hydraulic fluid from the hydraulic system to either the first actuator or the second actuator, and wherein the flow control valve is not part of the valve system of the tractor.
